(19) United States
(12) Patent Application Publication
(10) Pub. No.: US 2012/0282494 A1
(43) Pub. Date: Nov. 8, 2012

(54) BATTERY PACK

(75) Inventor: Young-Cheol Jang, Yongin-si (KR)

(73) Assignee: Samsung SDI Co., Ltd., Yongin-si (KR)

(21) Appl. No.: 13/244,021

(22) Filed: Sep. 23, 2011

Related U.S. Application Data
(60) Provisional application No. 61/482,142, filed on May 3, 2011.

(51) Int. Cl. H01M 2/00; H01M 10/00; H01M 2/12; H01M 2/02; H01M 2/36

(52) U.S. Cl. 429/7

(57) ABSTRACT

Disclosed is a battery pack including an electrode assembly; a battery case housing the electrode assembly; a cap assembly on one side of the battery case; and a protection circuit module coupled to the cap assembly, wherein the cap assembly comprises a side wall extending from an edge of the cap assembly, and the side wall covers a portion of the protection circuit module.

### RELATED APPLICATIONS

This application claims priority to and the benefit of U.S. Provisional Application No. 61/482,142, filed on May 3, 2011, the entire content of which is incorporated herein by reference.

### BACKGROUND

1. Field

Embodiments relate to a battery pack, and more particularly, to a battery pack including a protection circuit module and a bare cell.

2. Description of the Related Technology

Battery packs may be used in various shapes selected for application in various external electronic equipment and devices employing secondary batteries. Further, the battery pack effectively accumulates energy for its volume and weight, and thus is widely used for the power supply of portable electronic equipment.

In particular, with the development of portable communication devices, there is an increased demand for battery packs used for communication devices. The communication devices tend to be lighter and small-sized in view of portability. Accordingly, battery packs are also developed to be lighter and to have minimum volume. Also, since battery packs can have problems with safety, extensive studies have been conducted on battery packs with improved safety.

### SUMMARY

According to an embodiment, a battery pack comprises: an electrode assembly; a battery case housing the electrode assembly; a cap assembly on one side of the battery case; and a protection circuit module coupled to the cap assembly, wherein the cap assembly comprises a side wall extending from an edge of the cap assembly, and the side wall covers a portion of the protection circuit module.

According to an aspect, the cap assembly comprises a first surface area at one end of the cap assembly and a second surface area at an opposite end of the cap assembly, and wherein the first surface area is depressed relative to the second surface area.

According to an aspect, the protection circuit module includes a first portion at one end of the protection circuit module and a second portion at an opposite end of the protection circuit module, wherein the first portion corresponds to the first surface area of the cap assembly, wherein the second portion corresponds to the second surface area of the cap assembly, wherein the side wall surrounds the first surface area of the cap assembly, and wherein the first portion of the protection circuit module is inserted into a space formed by the first surface area and the side wall surrounding the first surface area.

According to an aspect, a surface of the first portion contacts the side wall as to couple the protection circuit module to the cap assembly. An adhesive member may be between a surface of the first portion and the side wall. The first portion of the protection circuit module may have a thickness that is greater than a thickness of the second portion of the protection circuit module. The first portion of the protection circuit module may comprise a conductive portion, and the second portion of the protection circuit module may comprise an external terminal unit. A spacer may be between the second portion of the protection circuit module and the second surface area of the cap assembly.

According to an aspect, the cap assembly further comprises an electrolyte inlet, and the spacer provides a space over the electrolyte inlet so that the electrolyte inlet is distanced from the external terminal unit. The conductive portion of the protection circuit module may have a shape corresponding to the side wall of the cap assembly. The conductive portion may comprise a portion of the protection circuit module plated with a conductive material.

According to an aspect, the electrode assembly comprises an electrode extending from the cap assembly, wherein the protection circuit module further comprises an opening exposing the electrode between the first and second portions, and an electrode lead disposed over the opening, wherein one end of the electrode lead is connected to the protection circuit module, and wherein another end of the electrode lead is connected to the electrode exposed through the opening. The electrode lead may comprise a positive temperature coefficient element.

According to an aspect, the protection circuit module further comprises an opening formed on a surface between the first and second portions, wherein the opening exposes an electrode extending from the cap assembly, and wherein the first portion of the protection circuit has a thickness that is greater than the thickness of the second portion of the protection circuit and that is greater than the thickness of the surface between the first and second portions.

According to an aspect, the cap assembly further comprises a first protrusion or first groove, and wherein the protection circuit module further comprises a first groove or first protrusion coupled with the first protrusion or first groove in the cap assembly, respectively.

According to an aspect, the cap assembly further comprises a second protrusion or second groove, wherein the first protrusion or first groove is at one end of the cap assembly and the second protrusion or second groove is at an opposite end of the cap assembly, wherein the protection circuit module further comprises a spacer between the second portion of the protection circuit module and the second surface area of the cap assembly, wherein the spacer comprises a second groove or second protrusion coupled with the second protrusion or second groove of the cap assembly, respectively.

According to an aspect, the battery case further comprises a vent to discharge gas.

### BRIEF DESCRIPTION OF THE DRAWINGS

The accompanying drawings, together with the specification, illustrate embodiments of the present invention, and, together with the description, serve to explain the principles of the present invention.

FIG. 1A is a perspective view of a battery pack according to an embodiment of the present invention;

FIG. 1B is an exploded perspective view of the battery pack according to an embodiment of the present invention;

FIG. 2 is a perspective view of a bare cell according to an embodiment of the present invention;

FIG. 3 is a perspective view of a protection circuit module according to an embodiment of the present invention;

FIG. 4A is a perspective view of the battery pack on which the protection circuit module is mounted;

FIG. 4B is a cross-sectional view, taken along line Y-Y of FIG. 4A;

FIG. 5 is a perspective view of a battery pack on which a protection circuit module is mounted according to another embodiment of the present invention; and

FIG. 6 is a perspective view of a battery pack on which a protection circuit module is mounted according to still another embodiment of the present invention.

### DETAILED DESCRIPTION

Reference will now be made in detail to certain embodiments of the present invention, examples of which are illustrated in the accompanying drawings. The embodiments are described below in order to explain the present invention by referring to the figures. This invention may, however, be embodied in many different forms and should not be construed as limited to the embodiments set forth herein. Rather, these embodiments are provided so that this disclosure will be thorough and complete, and will fully convey the scope of the invention to those skilled in the art. It will be understood that when an element or layer is referred to as being “on” or “connected to” another element or layer, the element or layer can be directly on the other element or layer, or the element or layer may be electrically connected to the other element or layer with intervening elements or layers being present. Also, description of unnecessary parts or elements may be omitted for clarity and conciseness, and like reference numerals refer to like elements throughout.

Hereinafter, embodiments of the present invention will be described in detail with reference to the accompanying drawings.

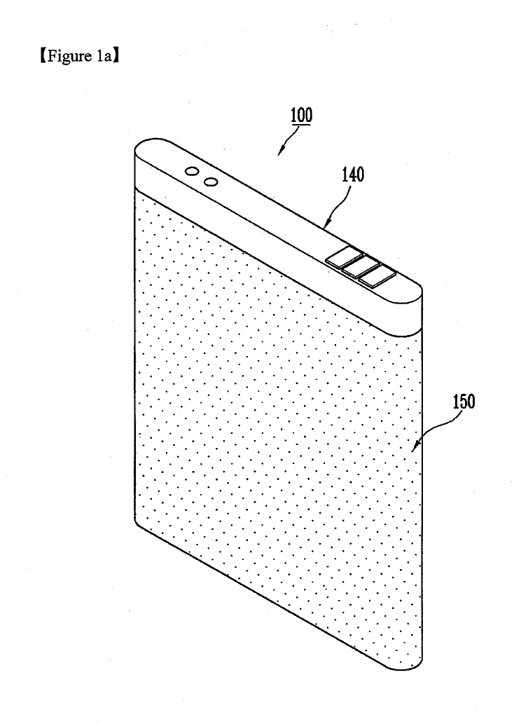

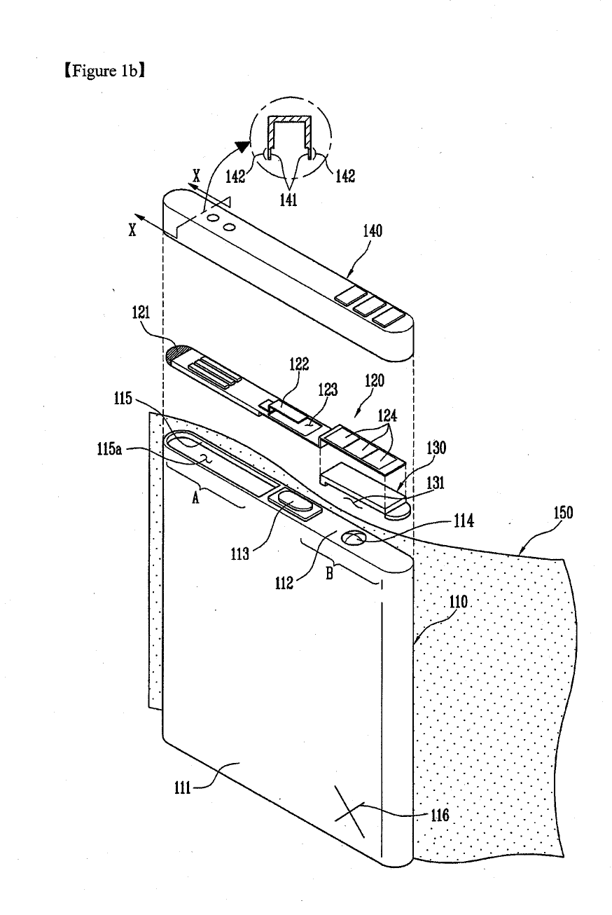

FIG. 1A is a perspective view of a battery pack according to an embodiment of the present invention, and FIG. 1B is an exploded perspective view of the battery pack according to the embodiment of the present invention.

The battery pack 100 according to the present embodiment includes a bare cell 110 having an electrode 113 and a protection circuit module 120 electrically connected to the bare cell 110, wherein the protection circuit module 120 is disposed on a first side 112 of the bare cell 110, a side wall 115 of the bare cell 110 covering at least part of the protection circuit module 120.

Referring to FIGS. 1A and 1B, the battery pack 100 may further include a top case 140 and a label 150. That is, the battery pack 100 is manufactured by mounting the protection circuit module 120 on the bare cell 100, covering the top case 140 to include the protection circuit module 120, and attaching the label 150 to a battery case 111. Here, the top case 140 is provided to cover the protection circuit module 120, and the label 150 is provide to cover a lateral side of the battery back 100 coupled with the top case 140.

Referring to the cross-sectional view taken along line X-X of FIG. 1B, the top case 140 may include a sleeve 142. Also, the top case 140 may further include a projection 141 formed inside corresponding to the sleeve 142.

The top case 140 may be provided to protect the protection circuit module 120 and to securely fix the protection circuit module 120 mounted on the bare cell 110. Thus, when the top case 140 is disposed on the bare cell 110, the projection 141 of the top case 140 is disposed over an edge portion of the bare cell 110 to cover the edge portion. Further, the sleeve 142 covering part of the bare cell 100 may be provided on an outside of the projection 141.

The label 150 may be attached to cover the bare cell 110 so as to include the sleeve 142 of the top case 140. Accordingly, the label 150 may securely couple the top case 140 to the bare cell 110 and also stably dispose the protection circuit module 120 on the bare cell 110. The label 150 may be, for example, a film including an adhesive member, such as a tape, and be provided to protect the appearance of the battery pack 100 and to identify the bare cell 110.

In addition, a terminal may be formed on one side of the top case 140 to connect the battery pack and an external electronic device.

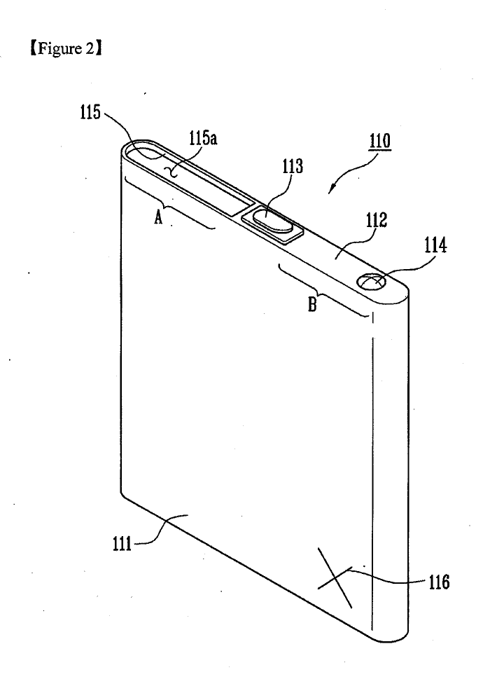

FIG. 2 is a perspective view of a bare cell according to an embodiment of the present invention.

Referring to FIG. 2, the bare cell 110 includes the battery case 111 having one open side and the first side 112 sealing the battery case 111. Here, the first side 112 may include a cap assembly 112, the battery case 111 may include a vent 116 to discharge gas, and the electrode 113 may be formed on the cap assembly 112.

The battery case 111 accommodates an electrode assembly including a positive plate, a negative plate and a separator disposed between the plates, and an electrolyte. Further, the cap assembly 112 may include the electrode 113 connected to the negative plate. The positive plate may be electrically connected to the cap assembly 112, and the negative plate may be electrically connected to the electrode 113. The positive plate and the negative plate react with the electrolyte to generate electrochemical energy, which is transmitted to the outside through the terminal.

Further, the cap assembly 112 may include an electrolyte inlet 114 formed on one side. The electrolyte inlet 114 may be a passage to inject the electrolyte into the bare cell 110 and may be formed by being sealed through welding or the like after injecting the electrolyte. Further, the battery case 111 may include the vent 116 on one side. When gas is generated in the bare cell 110 to cause an increase in internal pressure to a predetermined level or more, the vent 116 can function as a passage to discharge the gas to the outside, preventing the bare cell 110 from being damaged.

The bare cell 110 may further include a fuse. When a high voltage or high current is applied to the bare cell 110 or a high temperature occurs in the bare cell 110, the fuse can function to block electrical connection of the bare cell 110. The fuse is generally disposed on an outside of the bare cell 110.

In the present embodiment, the bare cell 110 is described with a lithium ion secondary battery having a square shape as an illustrative example. However, the bare cell 110 is not limited thereto but may be configured as various types and shapes of batteries, for example, a lithium polymer battery or a cylindrical battery.

The protection circuit module 120 may be formed on the cap assembly 112. Here, the side wall 115 of the bare cell 110 may be disposed to cover at least part of the protection circuit module 120. That is, the cap assembly 112 may include an accommodating part 115a, which is surrounded by the side wall 115, and the protection circuit module 120 may be seated on the accommodating part 115a, so that the side wall 115 is disposed to cover at least part of the protection circuit module 120.

The accommodating part 115a formed in the cap assembly 112 may be formed by deep drawing or the like and be disposed on a different side from the side where the electrolyte inlet 114 is formed. The accommodating part 115a may be a portion formed by deep drawing on a flat surface where any member, e.g., the electrolyte inlet 114 of the cap assembly 112, is not formed, the portion being formed in a lower step than a surrounding area, and the protection circuit module 120 may be inserted into the accommodating part 115a. That is, the cap assembly 112 may be divided into a first area A and a second area B based on the electrode 113, and the first area A may be formed in a lower step than the second area B.

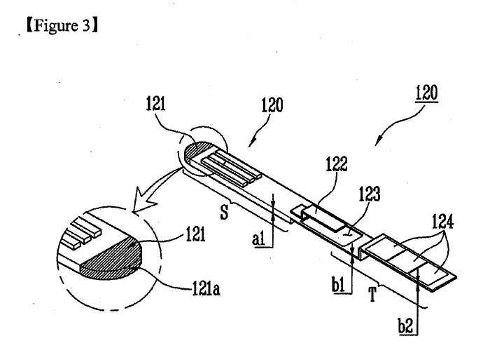

FIG. 3 is a perspective view of the protection circuit module according to an embodiment of the present invention.

Referring to FIG. 3, the protection circuit module 120 may be provided to control current or voltage applied to the bare cell 110 to thereby stably drive the battery pack 100 and may be formed by seating elements, such as a resistor or capacitor, on a plate-shape substrate. The protection circuit module 120 may include a conductive part 121, an opening 123, and an electrode lead 122.

The opening 123 may be formed in a position corresponding to the electrode 113 of the bare cell 110, and can enable the electrode 113, such as a negative pin, to be exposed, being electrically connected to the substrate of the protection circuit board 120, and can allow at least part of the protection circuit module 120 to be seated in the accommodating part 115a of the cap assembly 112. The opening 123, also referred to as an electrode through hole, may have a variety of shapes formed in the position corresponding to the electrode 113 to expose at least part of the electrode 113.

Further, the electrode lead 122 may be formed over the opening 123, one end portion of the electrode lead 122 being connected to the protection circuit module 120 and another end portion thereof being electrically connected to the electrode 113 exposed through the through hole 123. The electrode lead 122 may be electrically connected to the bare cell 110 through the opening 123. Further, the electrode lead 122 may further include a positive temperature coefficiency (“PTC”) device.

An external terminal unit 124 electrically connected to the outside may be formed on one side of the protection circuit module 120 based on the opening 123, and the conductive part 121 may be formed on a different side.

The protection circuit module 120 may include the conductive part 121, which may be in contact with the side wall 115 of the cap assembly 112 of the bare cell 110. Here, the conductive part 121 may have a shape corresponding to the side wall 115 of the bare cell 110.

That is, the conductive part 121 may be disposed on one end portion of the protection circuit module 120 and may be formed by plating, with a conductive material, at least part of an upper side of the protection circuit module 120, a lower side thereof and a lateral side 121a connecting the upper side and the lower side. For example, the conductive material may include at least one of copper, gold, silver and nickel. Further, the lateral side 121a of the conductive part 121 may have a shape corresponding to the side wall 115 formed in the cap assembly 112 of the bare cell 110.

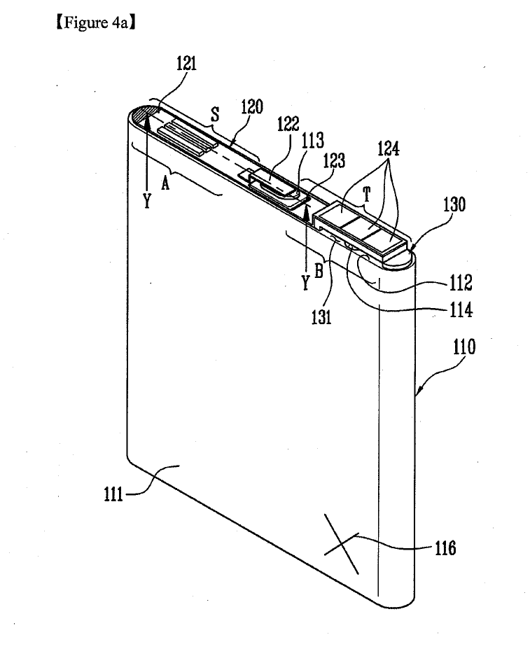

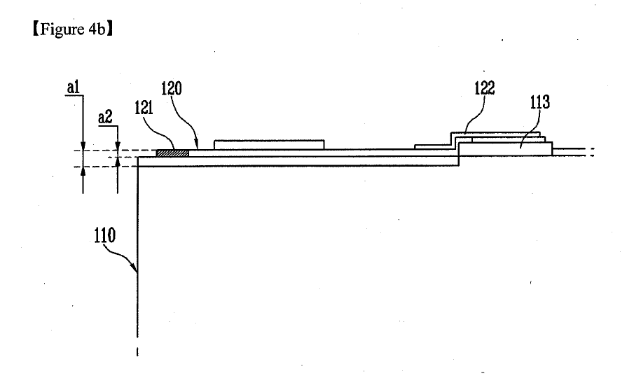

FIG. 4A is a perspective view of the battery pack on which the protection circuit module is mounted, and FIG. 4B is a cross-sectional view, taken along line Y-Y of FIG. 4A.

Referring to FIGS. 4A and 4B, the protection circuit module 120 may have a shape corresponding to the cap assembly 112 of the bare cell 110. Here, the protection circuit module 120 may be divided into a first part S and a second part T based on the opening 123. When the first part S corresponds to the first area A of the cap assembly 112, and the second part T corresponds to the second area B of the cap assembly 112, the thickness a1 of the first part S may be formed to be greater than the thickness b1 and b2 (see FIG. 3) of the second part T. When the thickness of the first part S is relatively great, the protection circuit module 120 can bear force when forcibly inserted. Further, when the thickness of the second part T is relatively small, the battery pack becomes small-sized and high-capacity.

Further, as described above, the second part T of the protection circuit module 120 may include the external terminal unit 124, and the thickness b1 and b2 of the second part T may be divided into the thickness of a portion where the opening 123 is formed and the thickness of a portion where the external terminal unit 124 is formed. Here, the thickness b1 and b2 of the second part T may be properly changed as long as it is smaller than the thickness a1 of the first part S. In the present embodiment, the thickness b1 of the portion where the opening 123 is formed and the thickness b2 of the portion where the external terminal unit 124 is formed are substantially similar to each other.

With the conductive part 121 of the protection circuit module 120 seated on the bare cell 110 in contact with the cap assembly 112, the cap assembly 112 functioning as a positive terminal may be electrically connected through the conductive part 121 plated with the conductive material. Here, the electrode 113 functioning as a negative terminal may be electrically connected to the protection circuit module 120 through the electrode lead 122 formed on the protection circuit module 120.

Generally, in order to stably realize electrical connection of the positive terminal and the negative terminal, a portion connected to a terminal may be welded. However, in the present embodiment, the conductive part 121 and the side wall of the cap assembly 115 may be formed to couple to each other, and the conductive part 121 may be formed to be inserted into the accommodating part 115a, and thus the assembly may be realized by forcible insertion without additional welding. Thus, a process of welding can be omitted, and accordingly a manufacturing process of the battery pack 100 may be simplified, reducing production costs. In addition, since at least part of the conductive part 121 can be inserted into the accommodating part 115a formed by the side wall 115, the protection circuit module 120 would not be easily detached from the bare cell 110 by external impact or the like.

After seating the protection circuit module 120 on the bare cell 110, a portion where the side wall 115 of the cap assembly 112 of the bare cell 110 is in contact with the protection circuit module 120 may further include an adhesive member, for example, silicone, epoxy or an adhesive. The conductive part 121 may be further securely attached to the bare cell 110 by the adhesive member.

A portion of the first part S of the protection circuit module 120 having a thickness excluding the thickness of the second part T from the thickness of the first part S may be inserted into the first area A of the bare cell 110. Also, a spacer 130 may be further formed between the second part T and the cap assembly 112. Here, the spacer 130 may have a shape corresponding to the cap assembly 112. For example, since the electrolyte inlet 114 may be formed to be embossed on the cap assembly 112, the spacer 130 having a space 131 in a lower part can be formed between the protection circuit module 120 and the cap assembly 112, thereby providing a space to the electrolyte inlet 114 of the cap assembly 112. Accordingly, the external terminal unit 124 formed on the protection circuit module 120 and the electrolyte inlet 114 will not interfere with each other. Further, an upper part of the spacer 130 may be formed to have a shape corresponding to the protection circuit module 120, thereby stably supporting the protection circuit module 120.

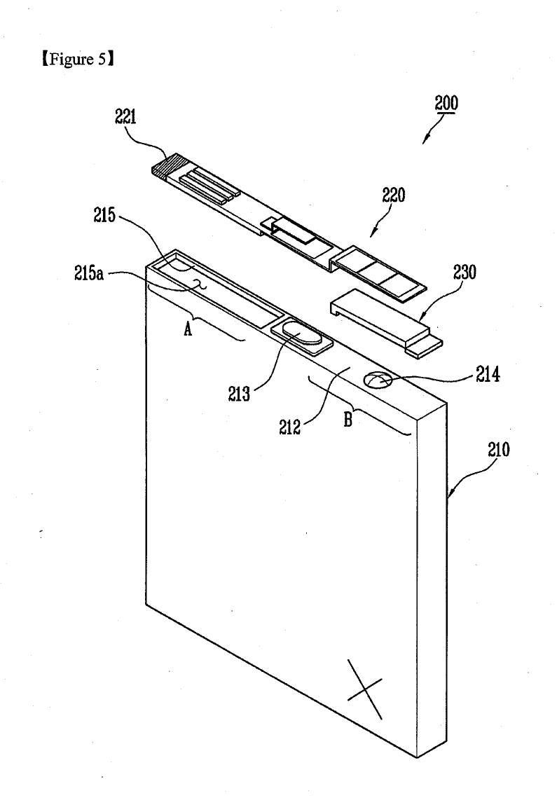

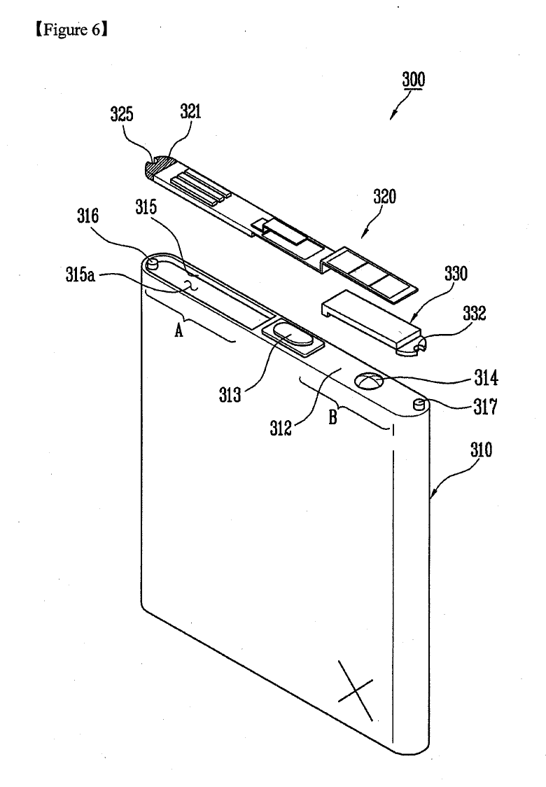

FIGS. 5 and 6 illustrate battery packs according to other embodiments of the present invention. Except for the following description, the constitution and functions of the present embodiment are similar to those described with reference to FIGS. 1 to 4, and thus descriptions thereof are omitted for clarity and conciseness.

FIG. 5 is a perspective view of a battery pack on which a protection circuit module is mounted according to another embodiment of the present invention.

Referring to FIG. 5, the battery pack 200 according to the present embodiment includes a bare cell 210 having an electrode 213 and a protection circuit module 220 electrically connected to the bare cell 210, wherein the protection circuit module 220 is coupled to a cap assembly 212 of the bare cell 210 and is disposed so that a side wall 215 of the cap assembly 212 covers at least part of the protection circuit module 220.

Further, a spacer 230 may be formed in a second area B between the protection circuit module 220 and the cap assembly 212 of the bare cell 210, thereby offsetting spatial limitation due to an electrolyte inlet 214.

The bare cell 210 according to the present embodiment has a nearly rectangular shape, and accordingly the cap assembly 212 has a nearly rectangular shape. Here, an accommodating part 215a having the side wall 215 is formed in a first area A of the cap assembly 212, and a conductive part 221 of the protection circuit module 220 is inserted into the accommodating part 215a so that at least part of the conductive part 221 is covered by the side wall 215.

The conductive part 221 may have a nearly rectangular shape corresponding to the shape of the cap assembly 212 of the bare cell 210. Here, the conductive part 221 is not limited to the shape of the cap assembly 212 as long as it is inserted into the accommodating part 215a of the cap assembly 212 to be in contact. However, in the conductive part 221 having a corresponding shape to the cap assembly 212, there is practically no space when a top case (not shown) is mounted thereon, thereby securely mounting the protection circuit module 220 on the bare cell 210 and reducing the volume of the battery pack 200.

Further, the spacer 230 is formed to have a shape corresponding to the cap assembly 212, thereby securely supporting the protection circuit module 220 and decreasing the volume of the battery pack 200.

FIG. 6 is a perspective view of a battery pack on which a protection circuit module is mounted according to still another embodiment of the present invention.

Referring to FIG. 6, the battery pack 300 according to the present embodiment includes a bare cell 310 having an electrode 313 and a protection circuit module 320 electrically connected to the bare cell 310, wherein the protection circuit module 320 is coupled to a cap assembly 312 of the bare cell 310 and is disposed so that a side wall 315 of the cap assembly 312 covers at least part of the protection circuit module 320. Further, a spacer 330 may be formed in a second area B between the protection circuit module 320 and the cap assembly 312 of the bare cell 310, thereby offsetting spatial limitation due to an electrolyte inlet 314.

In the bare cell 310 according to the present embodiment, protrusions 316 and 317 may be formed at opposite end portions of the cap assembly 312.

An accommodating part 315a formed in a first area A of the cap assembly 312 may include a protrusion 316, and a conductive part 321 may include a groove 325 in a position corresponding to the protrusion 316. When the protection circuit module 320 is mounted on the cap assembly 312, the conductive part 321 may be inserted into the accommodating part 315a, and accordingly the bare cell 310 may be electrically connected to the protection circuit module 320. Here, the protrusion 316 may be coupled to the groove 325 to secure connection of the protection circuit module 320 and the bare cell 310. Moreover, due to the groove 325 of the conductive part 321, the electrical contact area of the protection circuit module 320 with the bare cell 310 can be increased, thereby reducing resistance and easing electrical connection.

Also, the spacer 330 mounted in the second area B of the cap assembly 312 may include a groove 332, which is coupled to a corresponding protrusion 317, thereby securely fixing the spacer 330.

While the present invention has been described in connection with certain embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack comprising:
an electrode assembly;
a battery case housing the electrode assembly;
a cap assembly on one side of the battery case; and
a protection circuit module coupled to the cap assembly,
wherein the cap assembly comprises a side wall extending from an edge of the cap assembly, and the side wall covers a portion of the protection circuit module.

2. The battery pack of claim 1, wherein the cap assembly comprises a first surface area at one end of the cap assembly and a second surface area at an opposite end of the cap assembly, and wherein the first surface area is depressed relative to the second surface area.

3. The battery pack of claim 2, wherein the protection circuit module includes a first portion at one end of the protection circuit module and a second portion at an opposite end of the protection circuit module, wherein the first portion corresponds to the first surface area of the cap assembly, wherein the second portion corresponds to the second surface area of the cap assembly, wherein the side wall surrounds the first surface area of the cap assembly, and wherein the first portion of the protection circuit module is inserted into a space formed by the first surface area and the side wall surrounding the first surface area.

4. The battery pack of claim 3, wherein a surface of the first portion contacts the side wall as to couple the protection circuit module to the cap assembly.

5. The battery pack of claim 4, further comprising an adhesive member between a surface of the first portion and the side wall.

6. The battery pack of claim 3, wherein the first portion of the protection circuit module has a thickness that is greater than a thickness of the second portion of the protection circuit module.

7. The battery pack of claim 3, wherein the first portion of the protection circuit module comprises a conductive portion, and the second portion of the protection circuit module comprises an external terminal unit.

8. The battery pack of claim 7, further comprising a spacer between the second portion of the protection circuit module and the second surface area of the cap assembly.

9. The battery pack of claim 7, wherein the cap assembly further comprises an electrolyte inlet, and the spacer provides a space over the electrolyte inlet so that the electrolyte inlet is distanced from the external terminal unit.

10. The battery pack of claim 7, wherein the conductive portion of the protection circuit module has a shape corresponding to the side wall of the cap assembly.

11. The battery pack of claim 10, wherein the conductive portion comprises a portion of the protection circuit module plated with a conductive material.

12. The battery pack of claim 3, wherein the electrode assembly comprises an electrode extending from the cap assembly, wherein the protection circuit module further comprises an opening exposing the electrode between the first and second portions, and an electrode lead disposed over the opening, wherein one end of the electrode lead is connected to the protection circuit module, and wherein another end of the electrode lead is connected to the electrode exposed through the opening.

13. The battery pack of claim 12, wherein the electrode lead comprises a positive temperature coefficient element.

14. The battery pack of claim 7, wherein the protection circuit module further comprises an opening formed on a surface between the first and second portions, wherein the opening exposes an electrode extending from the cap assembly, and wherein the first portion of the protection circuit has a thickness that is greater than the thickness of the second portion of the protection circuit and that is greater than the thickness of the surface between the first and second portions.

15. The battery pack of claim 3, wherein the cap assembly further comprises a first protrusion or first groove, and wherein the protection circuit module further comprises a first groove or first protrusion coupled with the first protrusion or first groove in the cap assembly, respectively.

16. The battery pack of claim 15, wherein the cap assembly further comprises a second protrusion or second groove, wherein the first protrusion or first groove is at one end of the cap assembly and the second protrusion or second groove is at an opposite end of the cap assembly, wherein the protection circuit module further comprises a spacer between the second portion of the protection circuit module and the second surface area of the cap assembly, wherein the spacer comprises a second groove or second protrusion coupled with the second protrusion or second groove of the cap assembly, respectively.

17. The battery pack of claim 1, wherein the battery case further comprises a vent to discharge gas.
